(19) United States
(12) Patent Application Publication
(10) Pub. No.: US 2009/0020451 A1
(43) Pub. Date: Jan. 22, 2009

(54) Roller tray for a two-part coating package

(75) Inventors: Duberney Ospina, Laguna Beach, CA (US); Thomas R. Lee, Mission Viejo, CA (US); Jay Carl Langseder, Santa Ana, CA (US)

Correspondence Address: N. D. Parikh, Masco Corporation, 21001 Van Born Road, Taylor, MI, 48180, US

(73) Assignee: Behr Process Corporation

(21) Appl. No.: 11/879,089

(22) Filed: Jul. 16, 2007

(51) Int. Cl. B65D 25/00; B05C 21/00; B65D 85/00; B44D 3/06

(52) U.S. Cl. 206/568; 220/570

(57) ABSTRACT

A package for a two-part coating includes a container having an outer wall and at least one dividing wall extending across the outer wall to divide the container into at least first and second chambers that are separated from each other by the dividing wall. A roller tray has a longitudinal edge adapted removably to be received over the dividing wall such that the roller tray extends from the dividing wall over one of the chambers. In one exemplary embodiment of the present disclosure, at least one support leg extends from an opposing edge of the roller tray and is adapted removably to be received on the outer wall of the container. One edge of the roller tray preferably has a longitudinal slot adapted to be removably received over an upstanding lip on the dividing wall, and the opposing edge of the tray preferably has a spaced pair of support legs with feet adapted removably to be received by snap fit over an external lip on the outer wall of the container so that the tray is fully supported above the one chamber, preferably the “dry” chamber of the container.

The present disclosure relates to application of multi-part coatings, such as two-part epoxy paint, and more particularly to a package having a roller tray to facilitate application of such coatings.

### BACKGROUND AND SUMMARY OF THE DISCLOSURE

International patent publication WO 2006/049971A2 discloses a package for sale, storage and application of two-part coatings, which includes a container having a dividing wall and a lid removably received over an open end of the container in sealing engagement with the open end of the container and with the dividing wall. A liquid coating compound is disposed in one of the chambers and a second coating compound is within a package disposed in another of the chambers. The dividing wall has a series of ribs disposed in one of the chambers to facilitate roller application of the coating after the two components of the coating have been mixed. Disposition of the roller ribs on the dividing wall makes roller application of the mixed compound more difficult than desired and leaves a residue of compound removed from the roller in the chamber in which the ribs are disposed. A general object of the present disclosure is to provide a roller tray accessory for a package of this type that readily can be used in combination with the container and which leaves the “dry” chamber of the container dry after application of the coating.

The present disclosure embodies a number of aspects that can be implemented separately from or in combination with each other.

A package for a two-part coating, in accordance with one aspect of the present disclosure, includes a container having an outer wall and at least one dividing wall extending across the outer wall to divide the container into at least first and second chambers that are separated from each other by the dividing wall. A roller tray has a longitudinal edge adapted removably to be received on the dividing wall such that the roller tray extends from the dividing wall over one of the chambers. In one exemplary embodiment of the present disclosure, at least one support leg extends from an opposing edge of the roller tray and is adapted removably to be received on the outer wall of the container. One edge of the roller tray preferably has a longitudinal slot adapted to be removably received over an upstanding lip on the dividing wall, and the opposing edge of the tray preferably has a spaced pair of support legs with feet adapted to be removably received by snap fit over an external lip on the outer wall of the container so that the tray is fully supported above the one chamber, preferably the “dry” chamber of the container.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a perspective view of a package in accordance with an exemplary embodiment of the present disclosure;

FIG. 2 is a perspective view of the package in FIG. 1 with the lid removed;

FIG. 3 is a perspective view of the package in FIG. 2 with a roller tray in accordance with the present disclosure in operating position on the container;

FIG. 4 is a fragmentary perspective view on an enlarged scale of a portion of the package illustrated in FIG. 3;

FIG. 5 is a rear perspective view of the package in FIG. 3;

FIG. 6 is a fragmentary partially sectioned elevational view taken substantially along the line 6-6 in FIG. 5;

FIG. 7 is a side elevational view of the roller tray in the package of FIGS. 1-6;

FIG. 8 is a fragmentary view on an enlarged scale of the portion of FIG. 7 within the area 8;

FIG. 9 is a rear elevational view of the roller tray in FIGS. 7-8;

FIG. 10 is a bottom plan view of the roller tray in FIGS. 7-9;

FIG. 11 is a perspective view of a second exemplary embodiment of the present disclosure; and

FIGS. 12 and 13 are respective top and bottom perspective views of the roller tray in the package of FIG. 11.

### DETAILED DESCRIPTION OF PREFERRED EMBODIMENTS

The disclosure of above-noted International patent publication WO 2006/049971A2 is incorporated herein by reference.

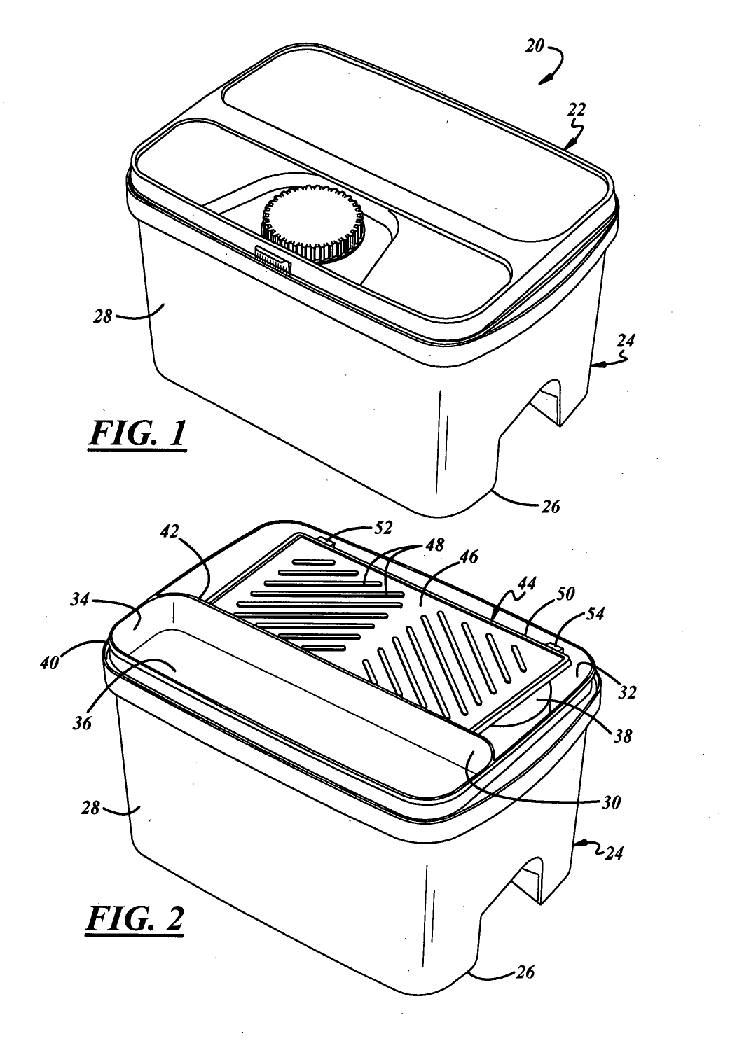

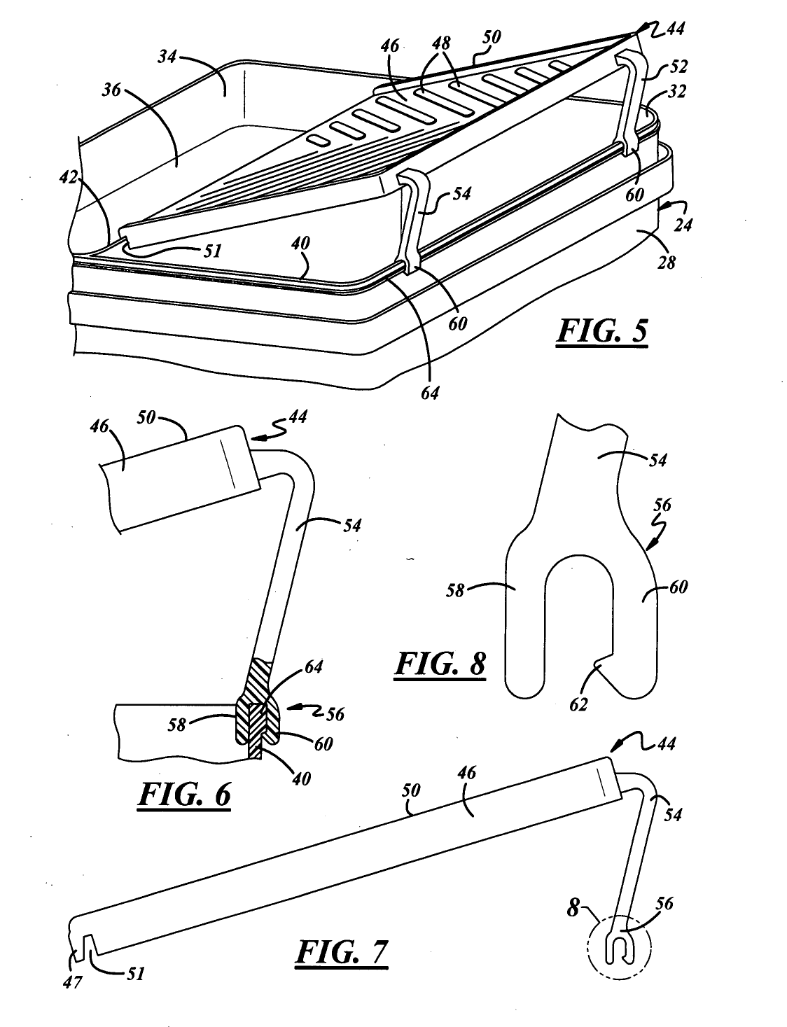

FIG. 1 illustrates a package 20 in accordance with an exemplary embodiment of the present disclosure as including a lid 22 removably received on a container 24. Container 24 preferably is one-piece and generally rectangular, and includes a base 26 and an upstanding outer wall 28. At least one dividing wall 30 (FIGS. 2-5) extends across outer wall 28 to divide the container into at least first and second chambers 32,34. In the exemplary embodiments of the present disclosure, chamber 34 is a “wet” chamber containing a liquid coating compound 36. Chamber 32 is a “dry” chamber containing at least one package 38 of a second coating compound to be mixed with coating compound 36 to form the two-part coating solution. Outer wall 28 preferably includes an upstanding lip 40 and dividing wall 30 preferably includes an upstanding lip 42. Lid 22 is adapted for sealing engagement with lips 40,42 to seal package 20. Dry chamber 32 may contain additional components such as paint brushes, cloths, stirrers, roller covers, etc. as described in the above-noted patent publication. Lid 22 and container 24 preferably are of plastic construction.

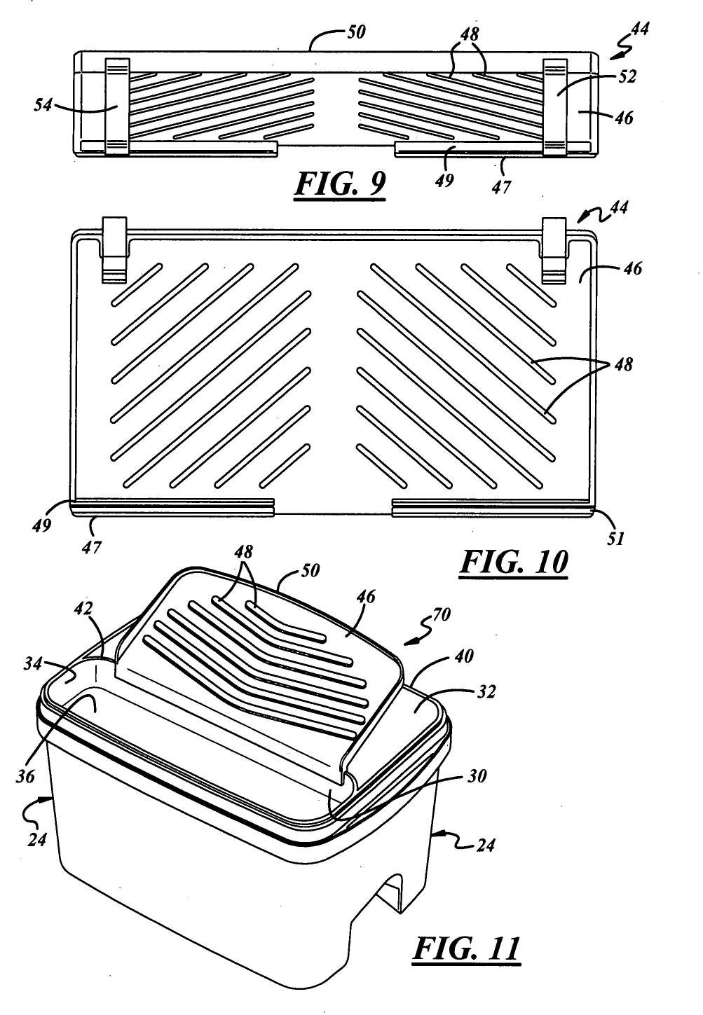

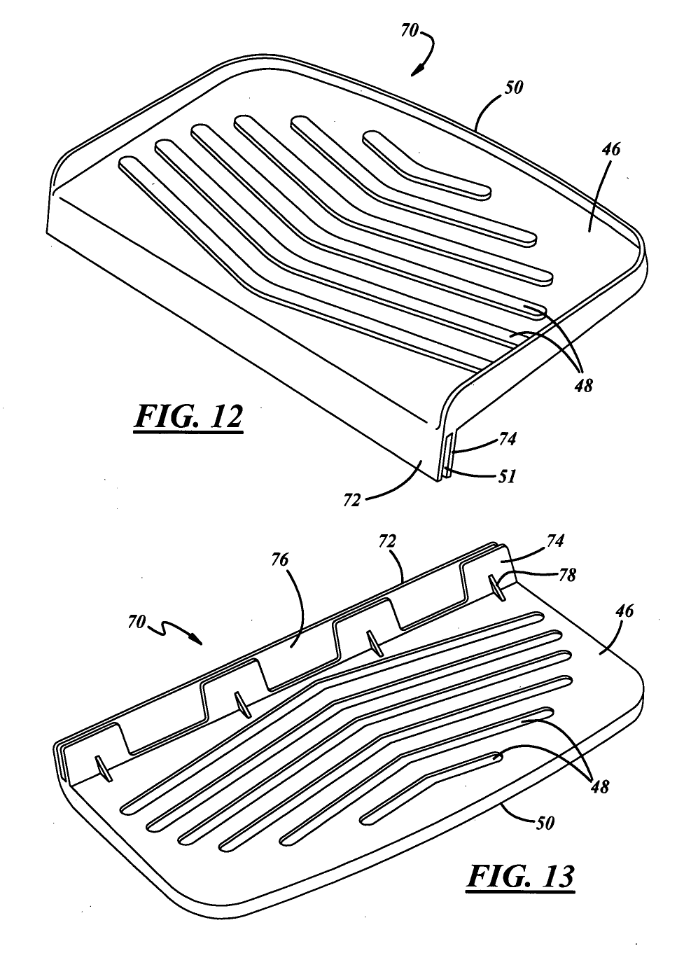

A roller tray 44 is disposed within chamber 32 and is removable from the chamber when lid 22 has been removed. Roller tray 44 includes a body 46, generally rectangular in the embodiment of FIGS. 1-10, having a generally flat upper surface with a plurality of upstanding ribs 48. Ribs 48 may be of any suitable geometry, of which two examples are illustrated in FIGS. 2 and 11. Roller tray body 46 preferably has a peripheral lip 50 that extends around three edges of the roller tray body. The fourth edge of the roller tray body preferably is substantially linear and includes a pair of underside flanges 46,48 (FIG. 10) that form a slot 50 extending along this straight edge of the roller tray body. Slot 50 is adapted to be removably received over upstanding lip 42 on dividing wall 30 so that roller tray 44 extends over dry chamber 32.

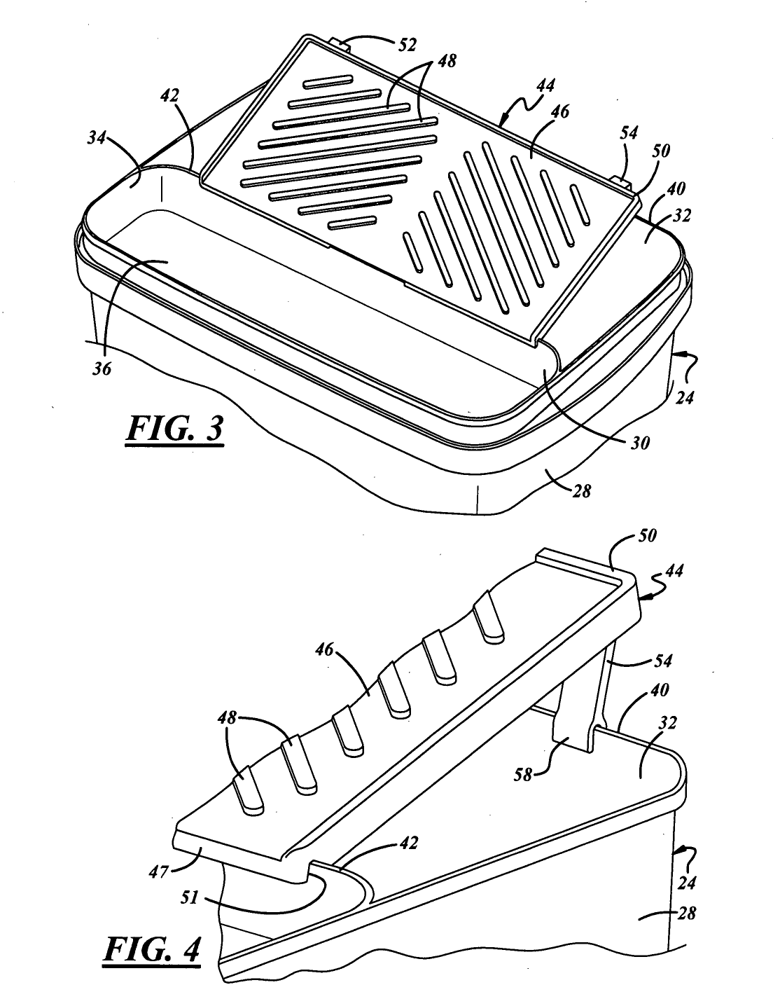

At least one support leg 52, and preferably a pair of longitudinally spaced support legs 52,54, extend from the back edge of tray body 46, that is, the edge of tray body 46 remote from slot 50. Each leg 52,54 preferably terminates in a foot 56 (FIGS. 6-8) having an inner toe 58 adapted slidably to be received within lip 40 and an outer toe 60 with an internal lug 62 adapted removably to be received by snap-fit over an external bead 64 on lip 40. Support legs 52,54 preferably are of one-piece unitary plastic construction with tray body 46, but could be provided separately from the tray body and attached to the tray body by a user. In assembly with container 24 (FIGS. 3-6), the back edge of roller tray 44 preferably generally overlies container outer wall 28. The front or inner edge of tag 44 thus is supported by dividing wall 30 while back or outer edge (in this embodiment) is supported by outer wall 28 so that the flat upper surface of tray body 46 is at an angle that slopes downward toward wet chamber 34.

With the two-part coating compounds suitably mixed in wet chamber 34 and roller tray 44 attached to container 24 as illustrated in FIGS. 3-6, the package is ready for use to apply the two-part coating solution. A roller may be dipped into chamber 34 to pick up some of the two-part coating solution and then engaged with ribs 48 on tray 46 in the usual manner to remove excess coating solution. Such excess coating solution flows inwardly and downwardly along the upper surface of tray 44, which preferably is angled in assembly as shown in the drawings, and flows back into chamber 34. Lip 50 helps prevent solution from flowing into chamber 32 and helps guide the solution back into chamber 34. Tray 44 can readily be removed from the container, cleaned and repositioned in chamber 32, and lid 22 can be resealed to the package between applications.

FIGS. 11-13 illustrate a roller tray 70 in accordance with a second exemplary embodiment of the disclosure. Roller tray 70 is similar in many respects to roller tray 46 discussed in detail above. Elements of tray 70 that are similar to corresponding elements in tray 46 are indicated by correspondingly identical reference numerals in FIGS. 11-13. Tray 70 differs from tray 46 primarily in that the back edge of tray 70 does not include one or more support legs 52,54. Rather, tray 70 is cantilevered in assembly over chamber 32 of container 24. Slot 50 of tray 70 is formed by an outer first flange 72 that preferably is continuous and extends along the entire linear front edge of tray 70, and by an interrupted second flange 74 formed in segments (FIG. 13) with gaps or spaces 76 between the segments. Gussets 78 extend from the undersurfaces of flange segments 74 to the undersurface of tray body 46 to strengthen flange segments 74.

There thus have been disclosed a package for a two-part coating, and a roller tray accessory for such a package, that fully satisfy all of the objects and aims previously set forth. The disclosure has been presented in connection with two exemplary embodiments, and a number of modifications and variations have been described. Other modifications and variations readily will suggest themselves to persons of ordinary skill in the art in view of the foregoing discussion. The disclosure is intended to embrace all such modifications and variations as fall within the spirit and broad scope of the appended claims.

1. A package for a two-part coating, which includes:
a container having an outer wall and at least one dividing wall extending across said outer wall to divide said container into at least first and second chambers that are separated from each other by said dividing wall, and
a roller tray having a longitudinal edge adapted removably to be received on said dividing wall such that said roller tray extends from said dividing wall over said first chamber

2. The package set forth in claim 1 wherein said roller tray includes a flat body extending from said edge and a plurality of upstanding ribs on said flat body.

3. The package set forth in claim 2 wherein said dividing wall has a linear upstanding lip and said roller tray has a slot extending along said edge and adapted removably to be received over said lip.

4. The package set forth in claim 3 wherein said slot is formed by a pair of spaced flanges extending along said edge of said tray.

5. The package set forth in claim 3 wherein said tray has an upstanding lip around edges of said body other than said longitudinal edge.

6. The package set forth in claim 3 wherein said roller tray includes at least one support leg extending from a second edge of said tray and adapted removably to be received on said outer wall of said container.

7. The package set forth in claim 6 wherein said roller tray includes a pair of said support legs spaced from each other and adapted removably to be received on said outer wall of said container.

8. The package set forth in claim 7 wherein said outer wall has an external lip and said support legs have feet adapted removably to be received by snap fit over said external lip.

9. The package set forth in claim 8 wherein said support legs are of one-piece plastic construction with said roller tray.

10. A package containing a two-part coating, which includes:
a one-piece generally rectangular plastic container having a base, an outer wall, at least one dividing wall extending across said outer wall and dividing said container into at least first and second chambers that are separated from each other by said dividing wall, and an open end spaced from said base,
a package of coating compound in a first of said chambers,
a liquid coating compound in a second of said chambers,
a roller tray in said first chamber, said roller tray having a longitudinal edge adapted removably to be received on said dividing wall such that said roller tray extends from said dividing wall over said first chamber, and
a plastic lid received over said open end of said container in sealing engagement with said open end around said outer wall and along said dividing wall.

11. The package set forth in claim 10 wherein said dividing wall has a linear upstanding lip and said roller tray has a slot extending along said edge and adapted removably to be received over said lip.

12. The package set forth in claim 11 wherein said slot is formed by a pair of spaced flanges extending along said edge of said tray.

13. The package set forth in claim 12 wherein said tray has an upstanding lip around edges of said body other than said longitudinal edge.

14. The package set forth in claim 10 wherein said roller tray includes at least one support leg extending from a second edge of said tray and adapted removably to be received on said outer wall of said container.

15. The package set forth in claim 14 wherein said roller tray includes a pair of said support legs spaced from each other and adapted removably to be received on said outer wall of said container.

16. The package set forth in claim 15 wherein said outer wall has an external lip and said support legs have feet adapted removably to be received by snap fit over said external lip.

17. The package set forth in claim 16 wherein said support legs are of one-piece plastic construction with said roller tray.

18. A roller tray for a container having spaced parallel walls, said roller tray including:
a flat plastic body having a straight longitudinal edge and a plurality of upstanding ribs,
a slot extending along said longitudinal edge for removable receipt over a lip on one of the container walls, and
at least one support leg extending from an edge of said body remote from said slot for removable receipt on a second wall of the container.

19. The roller tray set forth in claim 18 wherein said slot is formed by a pair of spaced flanges extending along said longitudinal edge of said body.

20. The roller tray set forth in claim 19 wherein said tray has an upstanding lip around edges of said body other than said longitudinal edge.

21. The roller tray set forth in claim 18 wherein said at least one support leg includes a pair of said support legs spaced from each other and adapted for removable receipt on a second wall of the container.

22. The roller tray set forth in claim 21 wherein said support legs have feet adapted for removable receipt by snap fit over an external lip on the second wall.

23. The roller tray set forth in claim 22 wherein said support legs are of one-piece plastic construction with said body.
